(19) United States
(12) Patent Application Publication
(10) Pub. No.: US 2021/0324813 A1
(43) Pub. Date: Oct. 21, 2021

(54) CONTROLLING AIR-FUEL RATIO FOR INTERNAL COMBUSTION ENGINES BASED ON REAL-TIME VOLUMETRIC EFFICIENCY DETERMINATION

(71) Applicant: BG SOFLEX LLC, Virginia Beach, VA (US)

(72) Inventors: Bruce A. Bowling, Linthicum Heights, MD (US); Albert C. Grippo, Virginia Beach, VA (US)

(21) Appl. No.: 16/852,780

(22) Filed: Apr. 20, 2020

(51) Int. Cl. F02D 41/18; F02D 41/00

(52) U.S. Cl. CPC F02D 41/18; F02D 41/009; F02D 2200/0406; F02D 2200/0411; F02D 2200/0414; F02D 2200/0614; F02D 2200/101

(57) ABSTRACT

Methods and systems for real-time determination of volumetric efficiency for real-time control of air-fuel ratio for an internal combustion engine are provided. Sensors including Mass Air Flow (MAF) rate, Manifold Absolute Pressure (MAP), Manifold Intake Air Temperature (IAT), and engine RPM may be used to determine an actual air mass and theoretical maximum air mass for an engine cylinder during an intake stroke. This ultimately leads to the determination of engine Volumetric Efficiency (VE) may be determined in real-time based on the measured and calculated values for air mass, may provide VE information to an engine control system for real-time control of fuel system operation.

### BACKGROUND

### 1. Field

Aspects of the exemplary embodiments relate to internal combustion engines, and more particularly, but not necessarily exclusively, to determining volumetric efficiency of internal combustion engines to adjust the air-fuel ratio under various operating conditions.

### 2. Description of the Related Art

The need for control of the internal combustion engine (ICE) has been a requirement over the evolution of the four-stroke cycle engine. A four-stroke cycle engine is an internal combustion engine that utilizes four distinct piston strokes (intake, compression, power, and exhaust) to complete one operating cycle. The piston make two complete passes in the cylinder to complete one operating cycle. Control systems for ICEs have become more complex in order to meet the needs of increasing environmental and operational constraints. One area of focus relates to accurately controlling the air-fuel ratio (AFR) over all operational regions of the engine. To accurately control AFR, the amount of air mass entering the engine during the intake stroke should be accurately determined, and then matched with an appropriate mass fuel. Controlling the metered fuel accurately may be achieved with the use of fuel injectors of known flow rate.

Determining mass air is a more difficult because an ICE will exhibit different air ingestion values depending on operation conditions, for example, revolutions-per-minute (RPM) of the engine and load on the engine. The efficiency with which the engine can move the charge of fuel and air into and out of the cylinders is known in the art as volumetric efficiency (VE). VE is defined as the ratio of the mass density of air drawn into the cylinder during the intake stroke to the density of the same cylinder volume of air at atmospheric pressure and temperature.

In the automotive aftermarket and high performance engine markets, including non-emission-compliant ICE applications (e.g., off-road, racing, research and development, etc.), there is a wide range of possible engine configurations that continue to evolve over time. Any change or alteration of the ICE air path, for example, changes in the engine intake or exhaust paths, valve actuation camshaft, change in reciprocating components of the engine, etc., can require re-calibration of the engine control system.

The conventional method of ICE control system calibration for automotive aftermarket systems uses exhaust gas oxygen monitoring sensors, also known as universal exhaust gas oxygen (UEGO) sensors. A UEGO sensor determines the engine air-fuel ratio (AFR) based on exhaust gas composition, and provides a numeric indication of measured AFR. With the use of the UEGO sensor and a known set AFR target, the value of VE can be altered in order to match the target AFR based on the UEGO-measured AFR reading. The UEGO sensor is used as a feedback element in a control loop while the VE value used by the fuel control engine control unit (ECU) is adjusted such that the AFR measured by the UEGO sensor converges on a desired operating point. In this arrangement, VE is determined indirectly from the combustion exhaust gas composition.

Volumetric efficiency can be used to determine engine fuel requirements by, for example, using the speed-density (S-D) method. The S-D method determines instantaneous engine air flow using cylinder air density and engine RPM to determine a rate of air exchange. Aftermarket engine applications incorporate the S-D method of mass air determination in the Engine Management System (EMS) or ECU for calculating the mass fuel injection amount required. The engine VE is a calibration (a.k.a. tuning) input used in S-D controls. The S-D estimation method determines the amount of air within a cylinder to which fuel is added in an amount dictated by the desired air-fuel ratio based on a table programmed in the EMS or ECU. The S-D method provides an estimate on the air contained in the cylinder at which point fuel is added using this knowledge in order to fulfill the desired combustion AFR. UEGO sensor measurements may be used to make adjustments to the AFR determined by the AFR method.

Several issues can arise when utilizing UEGO sensors for determination of engine VE and corresponding intake mass-air. The use of exhaust gas composition is an indirect method that can include all the systematic errors introduced in the fuel delivery and UEGO measurement. These errors can include errors introduced by the UEGO sensor and controller, injector flow rate numerical errors, injector actuation (e.g., opening) time errors, injector fuel rail pressure errors, etc. These errors may be independent or correlated depending on the situation. Additional sources of error include UEGO errors introduced from external exhaust leaks and sensor head temperature regulation. Another error source is the response time of the UEGO sensor output relative to actual cylinder events. All of these errors can act in concert to significantly affect the validity of the indirect VE determination during various engine operating regions and conditions.

### SUMMARY

One or more exemplary embodiments provide systems and methods for determining volumetric efficiency of internal combustion engines to adjust the air-fuel ratio under various operating conditions.

According to various aspects there is provided a method for controlling air-fuel ratio (AFR) of an internal combustion engine (ICE). In some aspects, the method may include measuring a mass air flow (MAF) rate of air entering the ICE during an intake stroke of the ICE; calculating a mass of the air entering the ICE based on the MAF rate; calculating, using a speed-density estimation, an estimated maximum mass of air that could be contained in a cylinder of the ICE; calculating an instantaneous volumetric efficiency (VE) value of the cylinder as a ratio of the mass of the air entering the ICE to the estimated maximum mass of air; and controlling the AFR of the ICE by utilizing the instantaneous VE to determine an amount of fuel delivered by a fuel injector.

According to various aspects there is provided a system for controlling air-fuel ratio (AFR) of an internal combustion engine. In some aspects, the system may include: a mass air flow (MAF) rate sensor; a manifold absolute pressure (MAP) sensor; a manifold absolute temperature (MAT) sensor; and a processor in communication with the MAF rate sensor, the MAP sensor, and the MAT sensor. The processor may be configured to perform operations including: receiving signals from the MAF rate sensor measuring a mass air flow rate of air entering the ICE during an intake stroke of the ICE; calculating a mass of the air entering the ICE based on the mass air flow rate measured by the MAF rate sensor; and receiving a pressure signal from the MAP sensor and a temperature signal from the MAT sensor.

Based on the received pressure and temperature signals, the processor may be further configured to perform operations including: calculating an estimated maximum mass of air that could be contained in a cylinder of the ICE based on the pressure signal received from the MAP sensor and the temperature signal received from the MAT sensor; calculating an instantaneous volumetric efficiency (VE) value of the cylinder as a ratio of the mass of the air entering the ICE to the estimated maximum mass of air; and controlling the AFR of the ICE by communicating the instantaneous VE to an engine management system to determine an amount of fuel delivered by a fuel injector.

According to various aspects there is provided a non-transitory computer readable medium. In some aspects, the non-transitory computer readable medium may include instructions for causing one or more processors to perform operations including: receiving measurements of a mass air flow (MAF) rate of air entering the ICE during an intake stroke of the ICE; calculating a mass of the air entering the ICE based on the MAF rate; calculating, using a speed-density estimation, an estimated maximum mass of air that could be contained in a cylinder of the ICE; calculating an instantaneous volumetric efficiency (VE) value of the cylinder as a ratio of the mass of the air entering the ICE to the estimated maximum mass of air; and controlling the AFR of the ICE by utilizing the instantaneous VE to determine an amount of fuel delivered by a fuel injector.

### BRIEF DESCRIPTION OF THE DRAWINGS

The above and other aspects will become more apparent by describing in detail exemplary embodiments with reference to the attached drawings in which:

FIG. 1 is a cross section of an example of an internal combustion engine illustrating one cylinder according to some aspects of the present disclosure;

FIG. 2 is a cross section of the internal combustion engine as illustrated in FIG. 1 showing sensors added to the internal combustion engine according to some aspects of the present disclosure;

FIG. 3 is a block diagram of a system for determining volumetric efficiency of an internal combustion engine according to some aspects of the present disclosure;

FIG. 4 is a flowchart of a method for controlling the air-fuel ratio of an internal combustion engine based on volumetric efficiency; and

FIG. 5 is a diagram illustrating a test apparatus for electronic fuel injector calibration according to various embodiments.

### DETAILED DESCRIPTION

The determination of engine volumetric efficiency (VE) is part of the ICE calibration procedure performed by Original Equipment Manufacturers (OEMs) during the commissioning of a new vehicle or engine platform. Volumetric efficiency information is used in the control of an ICE to meet various environmental standards as well as to assist the engine control system in maintaining stoichiometric operation and exhaust catalyst management. For example, VE information may be used to provide feed-forward calculations of engine fueling requirements at a given engine operating point. The calibration of VE is dependent on engine configuration, and re-calibration of VE may be required for any change in hardware configuration (e.g., changes in the engine intake or exhaust paths, valve actuation camshaft, change in reciprocating components of the engine, etc.) or application (e.g., off-road, racing, etc.) of the ICE.

Such changes affect the engine cylinder filling capacity. The engine cylinder filling capacity may be expressed as VE as a percentage of cylinder fill of air compared to an ideal situation based on current environment. The VE of an engine is not constant; rather it can change depending on applied engine load and engine RPM. The engine VE can be expressed as a two-dimensional table of numeric values indexed by real-time engine operating load and RPM values during engine operation. Engine VE is affected by several factors, including residual exhaust gas quantity left over from the previous internal combustion cycle, air momentum effects during engine intake, and errors in determination of cylinder air pressure and temperature.

The method for determining VE can use the standard definition, which defines VE as the actual amount of intake air in the cylinder compared to the theoretical amount of combustible air a cylinder could possibly contain. Volumetric efficiency is a reference to the air exchange process of an ICE; no reference to a fuel component is included.

To determine the VE from engine intake mass air flow rate directly, it is possible to employ several sensors of differing types in order to bring together the different portions of the VE calculation. Actual engine intake mass air flow rate can be measured using a mass air flow (MAF) rate sensor such as a hot-wire anemometer sensor or laminar-flow element positioned such that all of the incoming engine air to the ICE passes thru the sensor. Engine cylinder intake stroke air pressure and air temperature can be estimated from direct monitoring of the intake manifold absolute pressure (MAP) and intake manifold absolute temperature (MAT), and engine RPM.

The VE calculation may be performed in real-time (e.g., as the measurements are obtained) using a microcontroller, microprocessor, or programmable logic, or other programmable device. The resultant VE values may be output to the ICE control system (e.g., the EMS, ECU, or other control unit) to control the AFR of the engine. For example, the EMS, ECU, or other control unit may use the calculated VE at least in part to control the amount of fuel injected for the current cylinder by an electronic fuel injector. Alternatively, the resultant VE values may then be displayed to the user numerically via a user interface (UI), or recorded in a manner such that the values can be reviewed at a later time to be used for engine calibration. Systems and methods according to the present disclosure may be used with fuel injection systems and carbureted fuel system of ICEs to measure VE and record VE values for control and adjustment of various ICE operating parameters, for example, but not limited to, AFR, ignition timing, throttle position, variable valve timing, etc.

In the following description, various examples will be described. For purposes of explanation, specific configurations and details are set forth in order to provide a thorough understanding of the examples. However, it will also be apparent to one skilled in the art that the example may be practiced without the specific details. Furthermore, well-known features may be omitted or simplified in order not to obscure the embodiments being described.

According to an aspect of an exemplary embodiment, there is provided systems and methods for determining the volumetric efficiency of an internal combustion engine. The determined volumetric efficiency may be input to the engine control system as parameter for controlling the fuel injection system to adjust the air-fuel ratio under various operating conditions.

Embodiments according to the present disclosure may determine the instantaneous real-time numerical value of the VE for an ICE, where the VE may be defined as the ratio of actual mass of engine intake air within a cylinder divided by the theoretical mass of air the cylinder could actually hold based on environmental factors such as cylinder pressure, temperature, and volume. The VE of an ICE may be determined as shown in Equation 1:

$$V E = \frac{Actual Mass of Air In Cylinder}{Theoretical Maximum Mass of Air In Cylinder} . \qquad ( 1 )$$

Referring to Equation 1, VE is a numerical ratio indicator of the amount of combustible air contained in the cylinder. While an ICE cylinder contains air at all times, the air within the cylinder will be a sum of the air exchange that occurred during the intake stroke plus the residual exhaust gas from the previous cycle. Additionally, air momentum effects during the intake stroke, for example, air flow transients caused by changes in engine RPM, can increase or decrease the air density within the cylinder. Temperature changes within the intake mixture may also affect density of air within the cylinder. In addition, sensor limitations and sampling resolutions can affect the accuracy of the numeric value of VE.

Referring again to Equation 1, the numerator (e.g., the actual mass of air in the cylinder) can be obtained with the use of a physical device that directly measures mass air flow rate on the intake of the ICE. Such devices may include sensors, for example, but not limited to, hot-wire element anemometers, also known as mass air flow (MAF) rate sensors or meters. Other MAF rate measurement devices may include laminar flow elements and metered orifices, both of which utilize pressure gradient measurements across a known restriction to determine MAF rate. The MAF rate measurement device may be positioned within the intake air stream of the ICE in order to measure the entire MAF rate. In some embodiments, the MAF rate measurement device may be positioned before the intake air throttle (e.g., between the outside air and the intake air throttle) such that the entire air consumption of the engine can be measured. Since the MAF rate sensor provides a rate quantity of mass air flow rate, the processor may integrate the mass air flow rate received from the MAF rate sensor over the intake stroke time of the engine.

The denominator of Equation 1 (e.g., the theoretical maximum mass of air the cylinder can hold), and may be determined by knowledge of the air density in the cylinder for a given environment and volume. An estimate of the air within the cylinder at any given time can be obtained from the ideal gas law (Equation 2):

PV=mRT (2)

where P represents cylinder pressure, V represents cylinder volume, m is the mass of air when R is chosen to take the molar weight of air into account, R is the universal gas constant, and T is the air temperature in degrees K. In the case of the cylinder, the pressure P in the cylinder can be estimated from the intake manifold absolute pressure (MAP). The temperature in the cylinder can be estimated from the intake manifold absolute temperature (MAT). The volume V is the cylinder volume at the point of closing of the intake valve, which is typically close to piston the bottom-dead-center (BDC) position of the piston in the cylinder.

With the proper selection of the universal gas constant, R, the term m in Equation 2 will represent the mass of air within the cylinder volume (e.g., number of molecules of air multiplied by the mass of one molecule of air) as given by Equation 3:

$$Mass Of Air = molecular weight of air = \cdot \frac{M A P * V}{R * T} . \qquad ( 3 )$$

Equation 3 determines the theoretical mass of air within one cylinder volume, based on measured manifold absolute pressure, intake air temperature, and cylinder volume. Equation 3 may be understood as representing the “density” portion of the general speed-density (S-D) relation that is used in ICE AFR estimation.

A “speed” term of the S-D equation may be derived from the engine RPM (revolutions per minute) which is converted from time units of minutes into seconds. and taking into account that a four-stroke cycle engine fills the cylinder every two revolutions, yields the following mass air flow rate equation for the entire IC engine:

$$Mass Air Flow Rate = \frac{M A P * V}{R * T} * \frac{R P M}{120} . \qquad ( 4 )$$

Substituting Equation 4 as the denominator and the measured actual MAF rate obtained from the MAF rate measurement device as the numerator in Equation 1, the instantaneous engine VE may be obtained from Equation 1 as Equation 5:

$$VE = \frac{Actual Mass of Air In Cylinder}{Theoretical Maximum Mass of Air In Cylinder} = \frac{mass air flow rate measured by MAF sensor}{\frac{MAP \cdot V}{R \cdot T} . \frac{R P M}{120}} . \qquad ( 5 )$$

The instantaneous VE calculated in real-time may be communicated to the ICE control system (e.g., the EMS, ECU, or other control unit) and used by the ICE control system at least in part to control the AFR of the engine. For example, the EMS, ECU, or other control unit may use the calculated VE at least in part to control the amount of fuel injected for the current cylinder by an electronic fuel injector.

Equation 5 represents the measurement of average rate of intake mass air based on a steady-state engine RPM. Changes in engine RPM will cause a corresponding change in MAF rate and can introduce manifold filling and emptying effects that can cause errors in MAF rate measurement readings. These errors may be caused by a sudden rush of air in or out of the manifold during transients caused by the RPM changes.

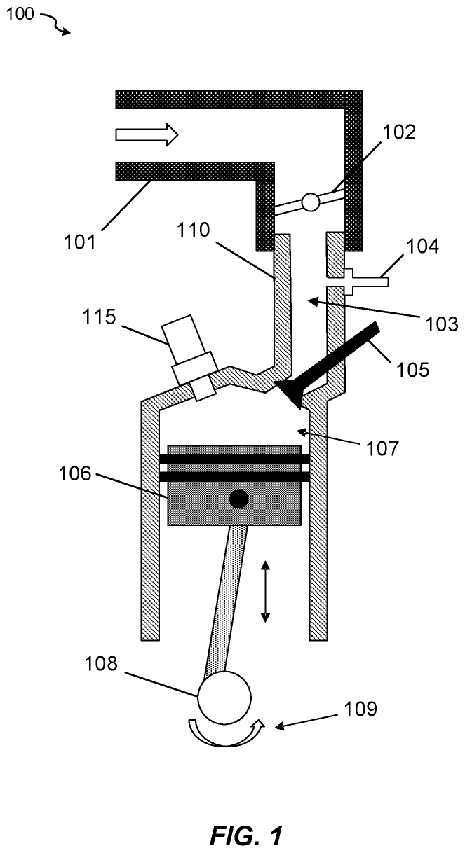

FIG. 1 is a cross-section of an example of an internal combustion engine 100 illustrating one cylinder according to some aspects of the present disclosure. A four-stroke cycle ICE utilizes four distinct piston strokes (intake, compression, power, and exhaust) to complete one operating cycle. The piston make two complete passes in the cylinder to complete one operating cycle. Referring to FIG. 1, the ICE 100 includes an air inlet tract 101, a throttle 102, an intake manifold 110, a measurement port 104, an electronic fuel injector 115, intake valve 105, a piston 106, a cylinder 107, and a crankshaft 108.

The air inlet tract 101 enables atmospheric air to be introduced to the ICE 100. The amount of inlet air can be controlled by the throttle 102. The throttle 102 controls the mass air quantity entering the cylinder 107. Below the throttle 102 is a region of air 103 that proceeds to the intake valve 105. This region of air 103 is the volume created by the intake manifold 110 and may be shared by a plurality of cylinders. The absolute pressure of the intake air can be measured at the measurement port 104. The electronic fuel injector 115 supplies a metered amount of fuel to the cylinder under control of the EMS or a fuel control ECU or other control unit. The piston 106 moves within in the cylinder 107 by means of the crankshaft 108 rotating at an angular velocity 109. The angular velocity 109 of the crankshaft 108 may be referred to as the engine RPM.

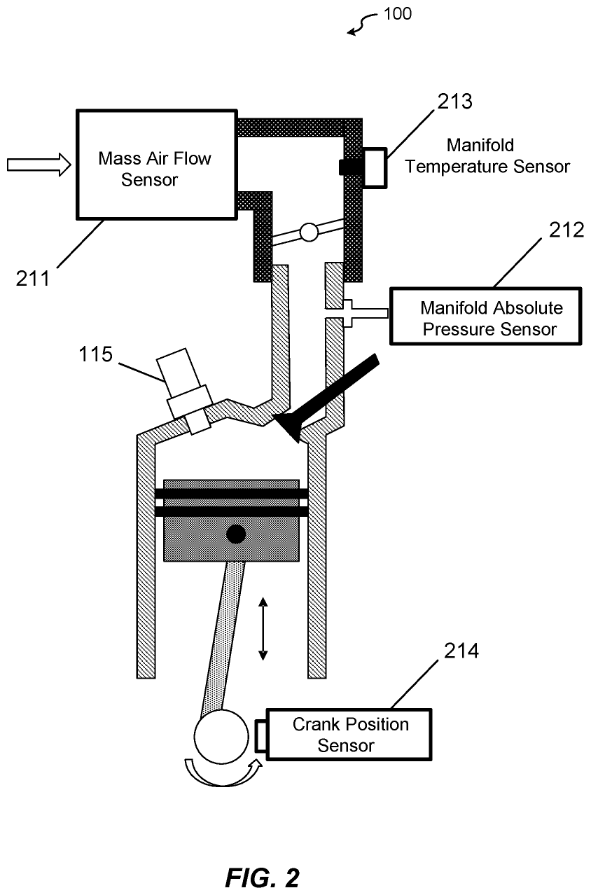

FIG. 2 is a cross section of the internal combustion engine 100 as illustrated in FIG. 1 showing sensors added to the internal combustion engine according to some aspects of the present disclosure. The added sensors include a MAF rate sensor 211, a manifold absolute temperature (MAT) sensor 213, a manifold absolute pressure (MAP) sensor 212, and a crankshaft absolute position (CAP) sensor 214.

Inlet mass air flow rate may be determined by the MAF rate sensor 211. The MAF rate sensor 211 may be a hot-wire anemometer sensor, a vortex sensor, laminar-flow element sensor, a calibrated orifice plate, or other type of MAF rate sensor. The MAF rate sensor 211 may produce an analog voltage output signal proportional to mass air flow rate, or a known frequency range output signal that relates to a calibrated range of mass air flow rates. The MAF rate sensor 211 may provide a measurement of the time rate of the mass of air entering the engine, for example, in units of grams per second or kilograms per hour. The MAF rate sensor 211 may be positioned such that the entire amount of air entering the engine is measured. In some implementations, one MAF rate sensor measures the sum mass air flow rate of a plurality of engine cylinders. In some implementations, individual MAF rate sensors may measure the mass air flow rate for each engine cylinder, and a numeric sum of the individual MAF rate sensors may be calculated, for example, by a processor, to determine the total mass air flow rate for the ICE.

The MAP sensor 212 may be used to estimate an absolute air charge pressure in the cylinder 107. The MAP sensor 212 may provide an analog voltage output signal that is proportional to absolute pressure. Alternatively, the MAP sensor 212 may provide a digital output signal that is proportional to absolute pressure via a digital-based interface such as a Serial Peripheral Interface (SPI), Inter-Integrated Circuit (I2C) interface, or other digital interface. Although the MAP sensor 212 may be positioned inside of the intake manifold 110, at certain points during the piston intake stroke (e.g., when the piston is at a point near BDC of the piston stroke, just before the intake valve closes), manifold absolute pressure is substantially the same as the pressure in the cylinder 107. and can be used as an indication of the absolute air charge pressure in the cylinder 107.

The temperature of the intake air charge may be sensed by the MAT sensor 213. While the MAT sensor 213 may be positioned in the intake manifold 110, the intake manifold air temperature is substantially the same as the air temperature in the cylinder 107. The MAT sensor 213 may provide an analog voltage output signal that is proportional to absolute pressure. Alternatively, the MAT sensor 213 may provide a digital output signal that is proportional to absolute pressure via a digital-based interface such as a Serial Peripheral Interface (SPI), Inter-Integrated Circuit (I2C) interface, or other digital interface.

Engine RPM may be measured using the CAP sensor 214. The CAP sensor 214 may be positioned near the ICE crankshaft 108. The CAP sensor 214 may be a variable-reluctance sensor or a Hall-Effect sensor or other type of RPM sensor and may be capable of detecting ferrous metals. A plurality of notches or other pattern on the crankshaft 108, or timing wheel (not shown) attached to the crankshaft 108, may be sensed by the CAP sensor 214 to generate pulses of a known frequency or repetition rate that is proportional to crankshaft rotational speed.

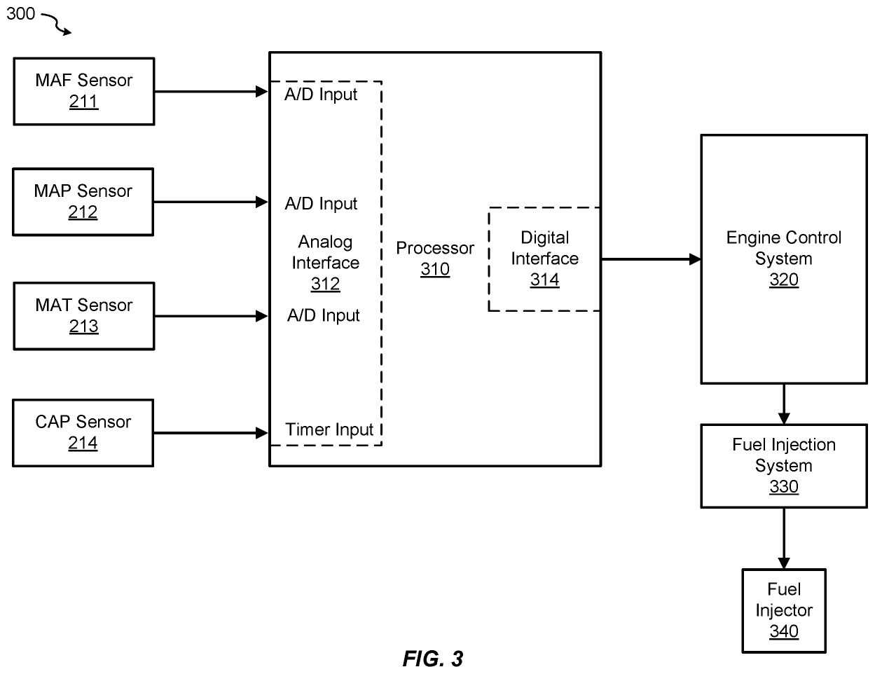

FIG. 3 is a block diagram of a system 300 for determining volumetric efficiency of an internal combustion engine according to some aspects of the present disclosure. Referring to FIG. 3, the system 300 may include a processor 310, a MAF rate sensor 211, a MAP sensor 212, a MAT sensor 213, and a CAP sensor 214. The MAF rate sensor 211, MAP sensor 212, MAT sensor 213, and CAP sensor 214 have been previously described with respect to FIG. 2 and will not be further described here.

The processor 310 may be a microprocessor, a microcontroller or other programmable logic device. The processor 310 may include supporting components including, for example, but not limited to, RAM and ROM memories, peripherals to support analog and time-based sensors, and various interfaces. The interfaces may be serial or parallel interfaces and may be analog or digital interfaces. The analog interface 312 may include analog-to-digital A/D converters. The digital interface 314 may include, for example, but not limited to, serial interfaces such as Serial Peripheral Interfaces (SPI), Controller Area Network bus (CAN Bus), Inter-Integrated Circuit (I2C) interfaces, Serial Universal Asynchronous Receiver/Transmitter (UART), or other digital interfaces.

Instantaneous VE values calculated by the processor 310 may be output to the engine control system 320, for example, the EMS or ECU or other controller, via the digital interface 314. The engine control system 320 may utilize the calculated VE at least in part to provide real-time control of the fuel injection system 330 to control the amount of fuel injected for the current cylinder by an electronic fuel injector 340.

The processor 310 may be programmed to sample the various sensor signals, perform calculations, for example, but not limited to VE calculations, and to output calculation results as a data stream. The processor 310 may perform calculations with sufficient resolution and at a rate of at least once per cylinder event at maximum engine RPM. In some implementations, the processor 310 may include the peripheral devices and data interfaces. In some implementations, external circuitry (not shown) may be used to support the peripherals or data interfaces or both. In some implementations, the processor 310 may be an external device to the engine control system. In other implementations, the processor 310 may be implemented as part of the engine control system, for example, within the EMS or ECU, and may perform calculations as part of or separate from other engine controls.

In some cases, some or all of the MAF rate sensor 211, the MAP sensor 212, the MAT sensor 213, and the CAP sensor 214 may be present in an existing ICE control system. When available, the existing sensors may be used to supply signals to the processor 310 for generating VE calculations, provided that the interface signals and the sensor ranges and resolutions of the ICE control system correspond to those of the processor 310.

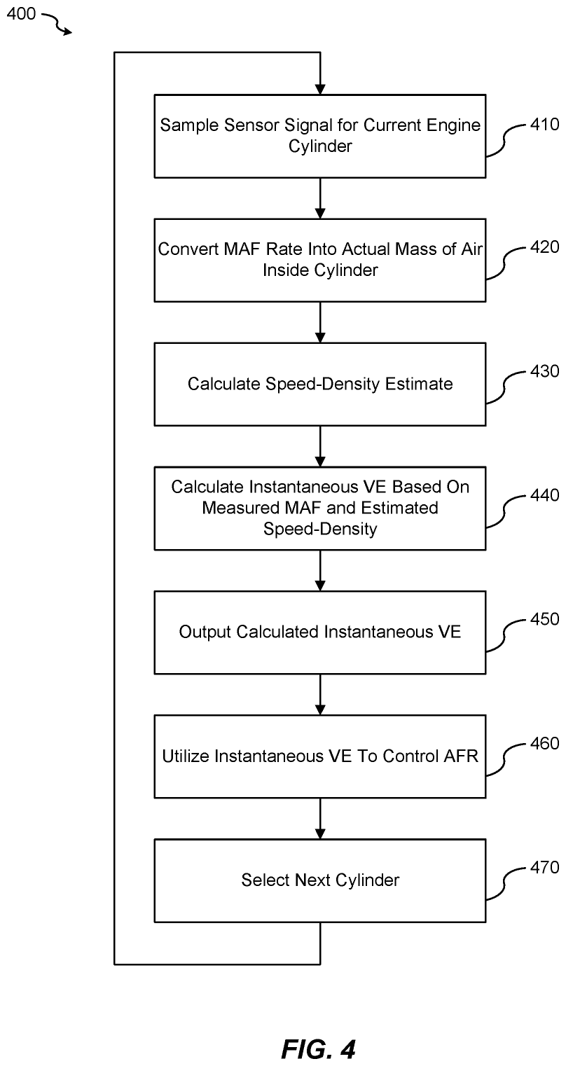

FIG. 4 is a flowchart of a method 400 for controlling the air-fuel ratio of an internal combustion engine based on volumetric efficiency according to some aspects of the present disclosure. After performing any processor and device setup and initialization, an infinite calculation loop may be initiated which samples the sensor signals, performs the calculations outlined in Equations 1-5, and provides real-time VE values on a serial data stream to the ICE control system to provide real-time control of the fuel injection system.

At block 410, the sensor signals may be sampled for a current cylinder. The processor may receive signals from the MAF rate sensor, the MAP sensor, the MAT sensor, and the CAP sensor. The processor may initiate sampling of the sensors for the current cylinder based on signals from the CAP sensor that indicate when a cylinder has received an air charge. Thus, sensor sampling and calculations will occur on each cylinder filling event (e.g., during an intake stroke of the piston). Analog-to-digital conversions may be performed on the MAF, MAP, and MAT sensor signals to obtain time-correlated measurement values.

At block 420, the MAF rate may be converted into the actual mass of air inside the cylinder. Since the MAF rate sensor provides a rate quantity of mass air flow rate, the processor may integrate the mass air flow rate received from the MAF rate sensor over the intake stroke time of the engine. The processor may determine the intake stroke time of the engine from the crankshaft RPM signal obtained from the CAP sensor.

At block 430, the Speed-Density estimation may be calculated. The processor may calculate the Speed-Density estimation of theoretical cylinder fill based on the values of the MAP and MAT, together with cylinder volume (a known value based on the engine) based on Equations 3 and 4. The processor may determine theoretical mass of air within one cylinder volume, based on measured manifold absolute pressure, intake air temperature, and cylinder volume, and the mass air flow rate may be determined taking into account that a four-stroke cycle engine fills the cylinder every two revolutions.

At block 440, the VE may be calculated based on the measured MAF rate and the calculated speed-density estimation. The processor may determine the instantaneous VE in real-time according to Equation 5 as the ratio of mass air flow rate measured by the MAF rate sensor to the Speed-Density estimation (e.g., Equation 4).

At block 450, the calculated instantaneous VE may be output in real-time to the engine control system as a serial data stream via the serial data interface such as a UART, CAN Bus, SPI, I2C, IP, or proprietary communications interface. In some implementations, the calculated instantaneous VE may be output to an external storage device (not shown).

At block 460, the calculated instantaneous VE may be utilized to control AFR. The calculated instantaneous VE may be utilized by the control system for the ICE (e.g., the ECU or EMS) to provide real-time control the AFR of the ICE. For example, the EMS or ECU may utilize the calculated instantaneous VE at least in part to provide real-time control of the fuel injection system to control the amount of fuel injected for the current cylinder by an electronic fuel injector 215. Alternatively or additionally, the calculated VE may be output to a data recording device, or a display device, or a combination of them.

At block 470, the next cylinder may be selected and the process may continue at block 410.

It should be appreciated that the specific steps illustrated in FIG. 4 provide a particular method for determining volumetric efficiency of an internal combustion engine according to an embodiment of the present invention. Other sequences of steps may also be performed according to alternative embodiments. For example, alternative embodiments of the present invention may perform the steps outlined above in a different order. Moreover, the individual steps illustrated in FIG. 4 may include multiple sub-steps that may be performed in various sequences as appropriate to the individual step. Furthermore, additional steps may be added or removed depending on the particular applications. Many variations, modifications, and alternatives may be recognized.

The method 400 may be embodied on a non-transitory computer readable medium, for example, but not limited to, a memory of the processor 310 or other non-transitory computer readable medium known to those of skill in the art, having stored therein a program including computer executable instructions for making a processor, computer, or other programmable device execute the operations of the methods.

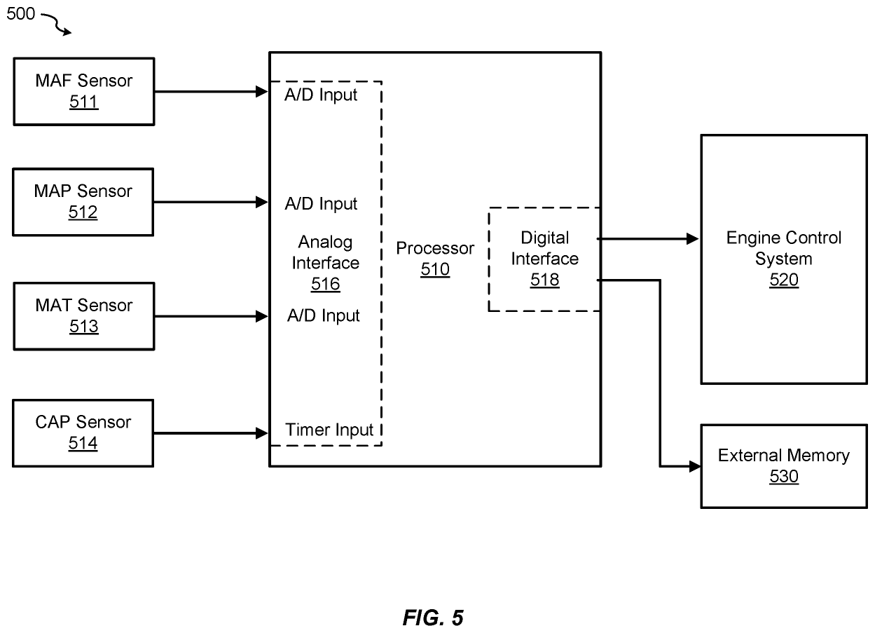

According to some aspects of the present disclosure, a method for determining the volumetric efficiency of an internal combustion engine may be performed on a test apparatus. FIG. 5 is a block diagram of a test apparatus 500 for determining volumetric efficiency of an internal combustion engine according to some aspects of the present disclosure. Referring to FIG. 5, the test apparatus 500 may include a processor 510, a MAF rate sensor 511, a MAP sensor 512, a MAT sensor 513, and a CAP sensor 514. The MAF rate sensor 511, MAP sensor 512, MAT sensor 513, and CAP sensor 514 have been previously described with respect to FIG. 2 and will not be further described here. In some implementations, the test apparatus 500 may include an external storage device 530. The external storage device 530 may be a separate storage device such as a disk drive or other storage device. In some implementations, the external storage device 530 may be a storage device of a laptop computer or other computer.

In some cases, some or all of the MAF rate sensor 511, the MAP sensor 512, the MAT sensor 513, and the CAP sensor 514 may be present in an existing ICE control system. When available, the existing sensors may be used to supply signals to the processor 510 for generating VE calculations, provided that the interface signals and the sensor ranges and resolutions of the ICE control system correspond to those of the processor 510. In some cases, the ICE control system may not include all of the MAF rate sensor 511, the MAP sensor 512, the MAT sensor 513, and the CAP sensor 514. In such cases, any sensors not present can be installed on the ICE.

The processor 510 may be a microprocessor, a microcontroller or other programmable logic device. The processor 510 may include supporting components including, for example, but not limited to, RAM and ROM memories, peripherals to support analog and time-based sensors, and various interfaces. The interfaces may be serial or parallel interfaces and may be analog or digital interfaces. The analog interface 516 may include analog-to-digital A/D converters. The digital interface 518 may include, for example, but not limited to, serial interfaces such as Serial Peripheral Interfaces (SPI), Controller Area Network bus (CAN Bus), Inter-Integrated Circuit (I2C) interfaces, Serial Universal Asynchronous Receiver/Transmitter (UART), or other digital interfaces. In some implementations, the processor 510 may be a processor of a laptop computer or other computer equipment.

In some implementations, instantaneous VE values calculated by the processor 510 may be output to the engine control system 520, for example, the EMS or ECU or other controller, via the digital interface 518. In some implementations, instantaneous VE values calculated by the processor 510 may be output to an external memory.

The processor 510 may be programmed to sample the various sensor signals, perform calculations, for example, but not limited to VE calculations, and to output calculation results as a data stream. The processor 510 may perform calculations with sufficient resolution and at a rate of at least once per cylinder filling event for each cylinder at maximum engine RPM. In some implementations, the processor 510 may include the peripheral devices and data interfaces. In some implementations, external circuitry (not shown) may be used to support the peripherals or data interfaces or both. The processor 510 may be an external device to the engine control system and may perform calculations separate from the engine controls.

After performing any processor and device setup and initialization, the processor 510 may initiate an infinite calculation loop that samples the sensor signals, performs the calculations outlined in Equations 1-5, and provides real-time VE values on a serial data stream to the ICE control system. In some implementations, the VE values may be transmitted to an external storage device.

The sensor signals may be sampled for a current cylinder. The processor may receive signals from the MAF rate sensor, the MAP sensor, the MAT sensor, and the CAP sensor. The processor may initiate sampling of the sensors for the current cylinder based on signals from the CAP sensor that indicate when a cylinder has received an air charge. Thus, sensor sampling and calculations will occur on each cylinder filling event (e.g., during an intake stroke of the piston). Analog-to-digital conversions may be performed on the MAF, MAP, and MAT sensors to obtain time-correlated measurement values.

The processor may convert the MAF rate into the actual mass of air inside the cylinder. Since the MAF rate sensor provides a rate quantity of mass air flow rate, the processor may integrate the mass air flow rate received from the MAF rate sensor over the intake stroke time of the engine. The processor may determine the intake stroke time of the engine from the crankshaft RPM signal obtained from the CAP sensor.

The Speed-Density estimation may be calculated. The processor may calculate the Speed-Density estimation of theoretical cylinder fill based on the values of the MAP and MAT, together with cylinder volume (a known value based on the engine) based on Equations 3 and 4. The processor may determine theoretical mass of air within one cylinder volume, based on measured manifold absolute pressure, intake air temperature, and cylinder volume, and the mass air flow rate may be determined taking into account that a four-stroke cycle engine fills the cylinder every two revolutions.

The VE may be calculated based on the measured MAF rate and the calculated speed-density estimation. The processor may determine the instantaneous VE in real-time according to Equation 5 as the ratio of mass air flow rate measured by the MAF rate sensor to the Speed-Density estimation (e.g., Equation 4). The calculated instantaneous VE may be output in real-time to the engine control system as a serial data stream via the serial data interface such as a UART, CAN Bus, SPI, I2C, IP, or proprietary communications interface.

In some embodiments, the calculated VE values may be programmed to a VE table for implementing control of various ICE operating parameters, for example, but not limited to air-fuel ratio, ignition timing, variable valve timing, etc., by the ECU. In some implementations, the instantaneous VE values calculated by the processor 510 may be output to an external memory for subsequent programming into a VE table stored in an ECU for implementing control of various ICE operating parameters, for example, but not limited to air-fuel ratio, ignition timing, variable valve timing, etc.

While the present inventive concept has been particularly shown and described with reference to exemplary embodiments thereof, various changes in form and details may be made therein. For example, while example embodiments have been described with respect to internal combustion engines having fuel injection systems, systems and methods of the present disclosure are applicable to internal combustion engines having carbureted fuel systems. Additional changes in form and details may be made without departing from the spirit and scope of the present inventive concept as defined by the following claims.

1. A method for controlling air-fuel ratio (AFR) of an internal combustion engine (ICE), the method comprising:
during ICE operation, for each cylinder of the ICE:
receiving, from a mass air flow (MAF) sensor, instantaneous measurements of MAF rate of air entering the ICE during intake strokes of the ICE;
calculating a mass of the air entering the ICE based on the MAF rate;
receiving instantaneous measurements of manifold absolute pressure (MAP) and manifold absolute temperature (MAT) from MAP and MAT sensors, respectively;
calculating a speed-density estimation using the instantaneous MAP, MAT, and MAF measurements;
calculating, using the speed-density estimation, an estimated maximum mass of air that could be contained in a cylinder of the ICE;
calculating an instantaneous volumetric efficiency (VE) value of the cylinder as a ratio of the mass of the air entering the ICE to the estimated maximum mass of air; and
controlling the AFR of the ICE according to the instantaneous VE to determine an amount of fuel to be delivered by a fuel injector for each cylinder.

2. The method of claim 1, further comprising calculating the instantaneous VE over a range of ICE operating conditions.

3. The method of claim 1, wherein the VE calculations are performed by a processor of an engine control unit (ECU).

4. The method of claim 1, wherein the VE calculations are performed at a rate of at least once per cylinder filling event for each cylinder at maximum engine RPM.

5. The method of claim 1, further comprising:
sampling signals received from the MAF, MAP, and MAT sensors for each of the cylinders based on signals received from a crankshaft absolute position (CAP) sensor indicating when each of the cylinders receives an air charge.

6. The method of claim 5, further comprising:
obtaining time-correlated measurement values from the signals received from the MAF, MAP, and MAT sensors.

7. The method of claim 1, further comprising:
integrating the MAF rate over an intake stroke time of the engine to obtain the actual mass of air inside the cylinder.

8. A system for controlling air-fuel ratio (AFR) of an internal combustion engine (ICE), the system comprising:
a mass air flow (MAF) rate sensor;
a manifold absolute pressure (MAP) sensor;
a manifold absolute temperature (MAT) sensor; and
a processor in communication with the MAF rate sensor, the MAP sensor, and the MAT sensor, the processor configured to perform operations for each cylinder of the ICE during ICE operation, the operations including:
receiving signals from the MAF rate sensor measuring an instantaneous mass air flow rate of air entering the ICE during intake strokes of the ICE;
calculating a mass of the air entering the ICE based on the mass air flow rate measured by the MAF rate sensor;
receiving pressure signals of instantaneous MAP measurements from the MAP sensor and temperature signals of instantaneous MAT measurements from the MAT sensor;
based on the received instantaneous MAP, MAT, and MAF signals, calculating a speed-density estimation;
calculating an estimated maximum mass of air that could be contained in a cylinder of the ICE using the speed-density calculation;
calculating an instantaneous volumetric efficiency (VE) value of the cylinder as a ratio of the mass of the air entering the ICE to the estimated maximum mass of air; and
controlling the AFR of the ICE according to the instantaneous VE by communicating the instantaneous VE to an engine management system to determine an amount of fuel to be delivered by a fuel injector for each cylinder.

9. The system of claim 8, wherein the processor is further configured to:
perform operations including calculating the instantaneous VE over a range of ICE operating conditions.

10. The system of claim 8, wherein the processor comprises an engine control unit (ECU).

11. The system of claim 8, wherein the processor is further configured to:
perform operations including performing the VE calculations at a rate of at least once per cylinder filling event for each cylinder at maximum engine RPM.

12. The system of claim 8, wherein the processor is further configured to:
sample the signals received from the MAF, MAP, and MAT sensors for each of the cylinders based on signals received from a crankshaft absolute position (CAP) sensor indicating when each of the cylinders receives an air charge.

13. The system of claim 12, wherein the processor is further configured to:
perform analog-to-digital conversion of the signals received from the MAF, MAP, and MAT sensors to obtain time-correlated measurement values.

14. The system of claim 8, wherein the processor is further configured to:
integrate the mass air flow rate signal received from the MAF rate sensor over an intake stroke time of the engine to obtain the actual mass of air inside the cylinder.

15. A non-transitory computer readable medium having stored therein instructions for making one or more processors execute a method for controlling air-fuel ratio (AFR) of an internal combustion engine (ICE), the processor executable instructions comprising instructions for performing operations for each cylinder of the ICE during ICE operation, the operations including:
receiving, from a mass air flow (MAF) sensor, instantaneous measurements of MAF rate of air entering the ICE during intake strokes of the ICE;
calculating a mass of the air entering the ICE based on the MAF rate;
receiving instantaneous measurements of manifold absolute pressure (MAP) and manifold absolute temperature (MAT) from MAP and MAT sensors, respectively;
calculating a speed-density estimation using the instantaneous MAP, MAT, and MAF measurements;
calculating, using the speed-density estimation, an estimated maximum mass of air that could be contained in a cylinder of the ICE;
calculating an instantaneous volumetric efficiency (VE) value of the cylinder as a ratio of the mass of the air entering the ICE to the estimated maximum mass of air; and
controlling the AFR of the ICE according to the instantaneous VE to determine an amount of fuel to be delivered by a fuel injector.

16. The non-transitory computer readable medium of claim 15, further comprising instruction for performing operations including:
calculating the instantaneous VE over a range of ICE operating conditions.

17. The non-transitory computer readable medium of claim 15, further comprising instruction for performing operations including:
performing the VE calculations at a rate of at least once per cylinder filling event for each cylinder at maximum engine RPM.

18. The non-transitory computer readable medium of claim 15, further comprising instruction for performing operations including:
sampling signals received from the MAF rate, MAP, and MAT sensors for each of the cylinders based on signals received from a crankshaft absolute position (CAP) sensor indicating when each of the cylinders receives an air charge.

19. The non-transitory computer readable medium of claim 18, further comprising instruction for performing operations including:
obtaining time-correlated measurement values from the signals received from the MAF rate, MAP, and MAT sensors.

20. The non-transitory computer readable medium of claim 15, further comprising instruction for performing operations including:
integrating a mass air flow rate signal received from the MAF rate sensor over an intake stroke time of the engine to obtain the actual mass of air inside the cylinder.
